(19) United States
(12) Patent Application Publication
(10) Pub. No.: US 2012/0133754 A1
(43) Pub. Date: May 31, 2012

(54) GAZE TRACKING SYSTEM AND METHOD FOR CONTROLLING INTERNET PROTOCOL TV AT A DISTANCE

(75) Inventors: Hee Kyung LEE, Daejeon (KR); Han Kyu LEE, Daejeon (KR); Ji Hun CHA, Daejeon (KR); Jin Woong KIM, Daejeon (KR); Kang Ryoung PARK, Seoul (KR); Hyeon Chang LEE, Gyeonggi-do (KR); Won Oh LEE, Seoul (KR); Chul Woo CHO, Seoul (KR); Su Yeong GWON, Seoul (KR); Duc Thien LUONG, Seoul (KR)

(73) Assignees: Dongguk University Industry-Academic Cooperation Foundation, Seoul (KR); Electronics and Telecommunications Research Institute, Daejeon (KR)

(21) Appl. No.: 13/162,199

(22) Filed: Jun. 16, 2011

(30) Foreign Application Priority Data
Nov. 26, 2010 (KR) 10-2010-0118583

(51) Int. Cl. H04N 7/18

(52) U.S. Cl. 348/78; 348/E07.085

(57) ABSTRACT

A remote gaze tracking apparatus and method for controlling an Internet Protocol Television (IPTV) are provided. An entire image including a facial region of a user may be acquired using a visible ray, the facial region may be detected from the acquired entire image, and a face width, a distance between eyes, and a distance between an eye and a screen may be acquired from the detected facial region. Additionally, an enlarged eye image corresponding to a face of the user may be acquired using at least one of the acquired face width, the acquired distance between the eyes, and the acquired distance between the eye and the screen, and an eye gaze of the user may be tracked using the acquired eye image.

### BACKGROUND

1. Field of the Invention

The present invention relates to a remote gaze tracking apparatus and method that may control an Internet Protocol Television (IPTV) and content using information on an eye gaze of a viewer in an IPTV environment, and more particularly, relates to an IPTV control interface that may enable a viewer to control a basic function of a TV, such as a channel change, a volume control, and the like, and may enable the viewer to conveniently use a variety of interactive content provided by the IPTV, for example an Internet search service, a Video on Demand (VoD) service, a chatting service, and the like.

2. Description of the Related Art

A gaze tracking method for controlling a screen of a display is divided into a wearable gaze tracking method, and non-wearable gaze tracking method.

In the wearable gaze tracking method, a user may wear a gaze tracking apparatus in his or her head or face. The user may feel uncomfortable because he or she has to wear the gaze tracking apparatus, prior to using a convenient function provided based on tracking of an eye gaze.

In the non-wearable gaze tracking method, a user does not need to wear a gaze tracking apparatus, however, may merely control a screen in a short distance, for example a computer monitor. In other words, the non-wearable gaze tracking method generally enables control of a display screen in a short distance, however, it is impossible to track an eye gaze within a general viewing distance, for example, in a range of 1 meter (m) to 3 m.

Additionally, most gaze tracking methods are used for specific purposes, for example, may be used to assist the physically disabled, or used as an implement for measuring and analyzing an eye gaze, and the like. Accordingly, ordinary people have difficulties to publicly use gaze tracking methods.

Recently, IPTV services are being spread and expanded. However, since most of the IPTV services employ a remote control of a complex button input mode, it is difficult for viewers to be familiar with various button functions.

### SUMMARY

According to an aspect of the present invention, there is provided a remote gaze tracking apparatus including: an infrared lighting unit to radiate a specular reflection of an infrared ray; a gaze image acquiring unit to acquire an entire image using a visible ray, and to acquire an enlarged eye image corresponding to a face of a user, the entire image including a facial region of the user; and a gaze tracking processor to track an eye gaze of the user, using the acquired entire image and the enlarged eye image.

According to another aspect of the present invention, there is provided a remote gaze tracking method including: acquiring an entire image using a visible ray, the entire image including a facial region of a user; detecting the facial region from the acquired entire image; acquiring, from the detected facial region, a face width, a distance between eyes, and a distance between an eye and a screen; acquiring an enlarged eye image corresponding to a face of the user, using at least one of the acquired face width, the acquired distance between the eyes, and the acquired distance between the eye and the screen; and tracking an eye gaze of the user using the acquired entire image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a remote gaze tracking apparatus according to an embodiment of the present invention;

FIG. 2 is a block diagram illustrating a remote gaze tracking apparatus according to an embodiment of the present invention;

FIG. 3 is a flowchart illustrating a remote gaze tracking method according to an embodiment of the present invention; and

FIG. 4 is a flowchart illustrating in more detail a remote gaze tracking method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

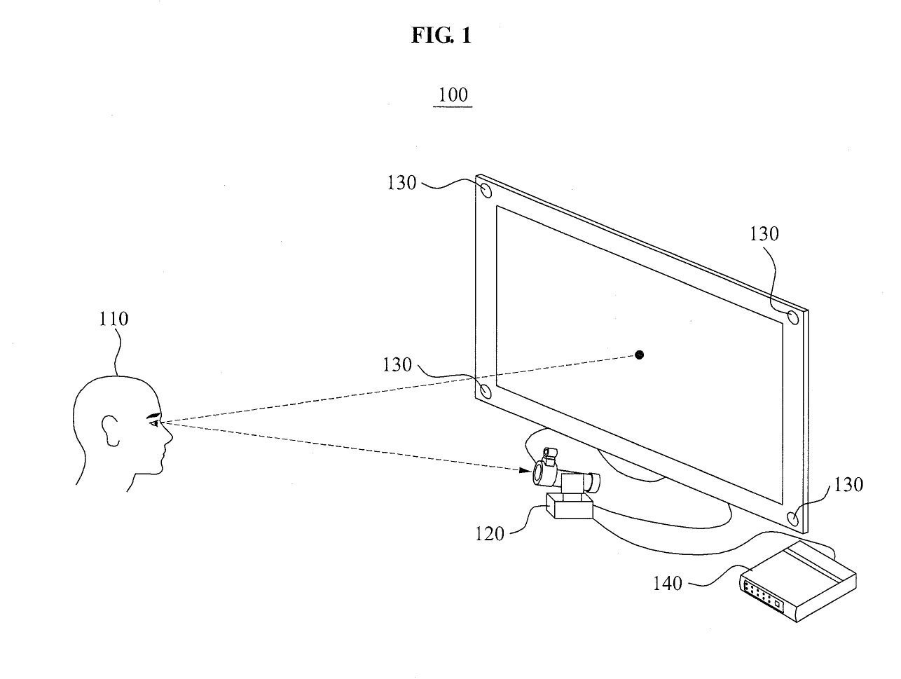

FIG. 1 is a diagram illustrating an example of a remote gaze tracking apparatus 100 according to an embodiment of the present invention.

The remote gaze tracking apparatus 100 may acquire an entire image including a facial region of a user 110, using a visible ray, and may detect the facial region from the acquired entire image.

Accordingly, a gaze image acquiring unit 120 may be used. The gaze image acquiring unit 120 may include a wide-angle camera, and a narrow-angle camera.

The gaze image acquiring unit 120 may include the wide-angle camera, the narrow-angle camera, and three motors. The wide-angle camera may be used to detect a face position and an eye position of the user 110 (hereinafter, referred to as a facial region). The narrow-angle camera may be equipped with a high magnification lens having an adjustable focus to obtain an enlarged eye image. Additionally, the three motors may be used to enable the narrow-angle camera to be panned, tilted, and focused.

In other words, the gaze image acquiring unit 120 may include the wide-angle camera to capture the entire face of the user, and the narrow-angle camera equipped with the high magnification lens that has the adjustable focus and that enables an eye region of the user to be magnified and captured for an eye tracking operation.

The wide-angle camera and the narrow-angle camera may have a structure in which an optic axis is parallel. The wide-angle camera and the narrow-angle camera may employ a Complementary Metal Oxide Semiconductor (CMOS) of a Universal Serial Bus (USB) interface or a Charge Coupled Device (CCD).

Additionally, to increase gaze tracking accuracy, a 2-megapixel camera may be used as the narrow-angle camera.

In the wide-angle camera for detecting the facial region, an image of a visible wavelength range may be acquired. In the narrow-angle camera for acquiring an enlarged eye image, an image of an infrared wavelength range may be acquired.

The gaze tracking processer 140 may acquire, from the detected facial region, a face width, a distance between eyes, and a distance between an eye and a screen, and may acquire the enlarged eye image corresponding to the face, using at least one of the acquired face width, the acquired distance between the eyes, and the acquired distance between the eye and the screen.

Specifically, the gaze tracking processer 140 may control an operation of the narrow-angle camera using at least one of the acquired face width, the acquired distance between the eyes, and the acquired distance between the eye and the screen, and may acquire a clear eye image.

Additionally, the gaze tracking processer 140 may track an eye gaze of the user 110 using the acquired eye image.

Specifically, the gaze tracking processer 140 may collect light obtained by reflecting, through a pupil region acquired by the eye image, specular reflections radiated by infrared lighting units 130 that are located in four corners of a screen, and may track the eye gaze of the user 110.

According to an embodiment of the present invention, a user may control an IPTV in a long distance, without wearing a separate apparatus. Additionally, the user may control the IPTV by merely staring at a TV screen, instead of using a remote control of a complex button input mode, and may conveniently use a variety of content.

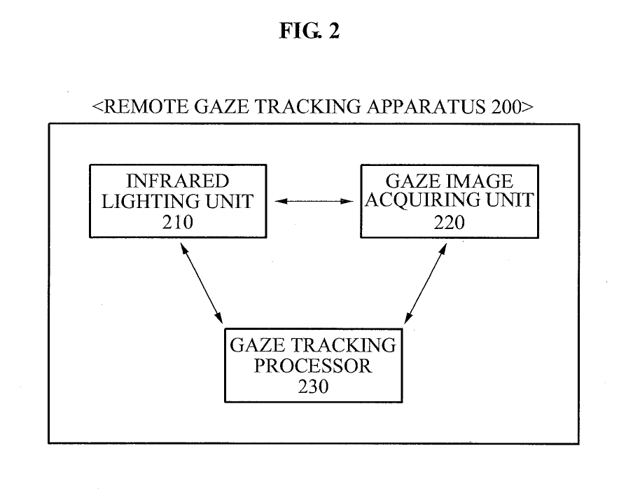

FIG. 2 is a block diagram illustrating a remote gaze tracking apparatus 200 according to an embodiment of the present invention.

The remote gaze tracking apparatus 200 may include an infrared lighting unit 210, a gaze image acquiring unit 220, and a gaze tracking processor 230.

The infrared lighting unit 210 may radiate a specular reflection of an infrared ray.

The infrared lighting unit 210 may be configured with an arrangement of multiple infrared Light Emitting Diodes (LEDs) in a wavelength of 850 nanometers (nm). For example, the infrared lighting unit 210 may be attached to a TV frame, or built in the remote gaze tracking apparatus 200, and may include four infrared lightings.

An infrared LED may be used to shine a viewer, and also be used to generate four specular reflections in order to track an eye gaze.

Additionally, the infrared LED may form a lighting enough to capture an eye image of a viewer that is suitable for eye gaze tracking within a typical TV viewing distance, namely, a range of 1 meter (m) to 3 m.

The gaze image acquiring unit 220 may acquire an entire image including a facial region of a user, using a visible ray, and may acquire an enlarged eye image corresponding to a face of the user.

The gaze image acquiring unit 220 may include a wide-angle camera to acquire the entire image, and a narrow-angle camera to acquire the enlarged eye image.

In other words, the gaze image acquiring unit 220 may approximately detect the facial region from a wide view angle by using the wide angle camera, and may then pan and tilt the narrow-angle camera to a position of the detected facial region. Accordingly, it is possible to more accurately measure a face position and eye position of a viewer in a long distance.

The gaze tracking processor 230 may track an eye gaze of the user, using the acquired entire image and the enlarged eye image.

Accordingly, the gaze tracking processor 230 may capture images from the wide-angle camera and the narrow-angle camera, may process the captured images, may control a motor to perform panning, tilting and focusing, and may perform a function of controlling the infrared lighting unit 210.

The gaze tracking processor 230 may apply an Adaboost algorithm and a CamShift algorithm in the acquired entire image, and may detect the facial region.

Specifically, the gaze tracking processor 230 may detect the facial region using the wide-angle camera by the Adaboost algorithm, may then measure and compare a histogram similarity using the CamShift algorithm, and may update the histogram similarity, to track the facial region.

Additionally, the gaze tracking processor 230 may compute at least one of a distance between eyes, and a distance between an eye and a screen, by applying the Adaboost algorithm and an adaptive template algorithm to the detected facial region.

Specifically, the gaze tracking processor 230 may detect an eye region using the wide-angle camera by the Adaboost algorithm, may then measure and compare a similarity using an adaptive template matching algorithm, and may update the similarity, so that the eye gaze may be accurately tracked.

Additionally, the gaze tracking processor 230 may control a movement of the narrow-angle camera, based on the acquired entire image, so that the enlarged eye image may be acquired.

Subsequently, the gaze tracking processor 230 may detect a pupil region of the user based on the acquired enlarged eye image, and may detect a pupil center position from the detected pupil region. Additionally, the gaze tracking processor 230 may detect the specular reflection reflected from the pupil region, and may track the eye gaze of the user.

To detect the pupil region, the gaze tracking processor 230 may use at least one of a circular edge detection algorithm, a binarization process, and a labeling process.

According to an embodiment of the present invention, it is possible to provide a customized advertisement by recognizing an eye gaze position of a user located in a long distance. Additionally, it is possible to determine whether a viewer is absent in front of a TV or is sleeping, and to provide a power-saving function by turning off the TV.

In other words, when a face is not detected by the wide-angle camera, or when a pupil is not detected by the narrow-angle camera even when the face is detected, a power-saving function to turn off a TV may be provided based on a determination that a viewer is absent in front of a TV or is sleeping.

Furthermore, according to an embodiment of the present invention, it is possible to measure a fatigue level of a user viewing a TV, and to control an image in order to reduce the fatigue level.

Accordingly, when the measured fatigue level is equal to or greater than a threshold, the gaze tracking processor 230 may control at least one of a hue, a brightness, and a saturation of an image displayed on a screen, to be adjusted.

To measure the fatigue level, the gaze tracking processor 230 may measure the fatigue level of the user by verifying the detected pupil region.

Specifically, the gaze tracking processor 230 may analyze a viewing pattern of a user, and may utilize the viewing pattern in advertisement display on a screen. Additionally, the gaze tracking processor 230 may measure an eye-blink speed and a pupil dilation/constriction speed, based on whether a pupil is detected by a narrow-angle camera, and based on a change in size of the pupil, and may determine the fatigue level of the user. Accordingly, it is possible to adjust a hue and a brightness of a screen based on the fatigue level.

The remote gaze tracking apparatus 200 may provide a screen optimized to various postures of a viewer, by rotating content displayed on the screen based on both eye positions detected from a user viewing a TV.

Accordingly, the gaze tracking processor 230 may control an image appearing on the screen to be rotated, using the enlarged eye image.

In other words, when a viewer watches a TV while lying in front of the TV, the remote gaze tracking apparatus 200 may propose a screen optimized to various postures of the viewer by rotating the screen based on both eye positions detected by the wide-angle camera.

Additionally, the remote gaze tracking apparatus 200 may provide a home security surveillance function, or a child monitoring function. In other words, the remote gaze tracking apparatus 200 may enable a camera in a remote place to be manually panned and tilted through a communication, and thus the home security surveillance function, or the child monitoring function may be provided.

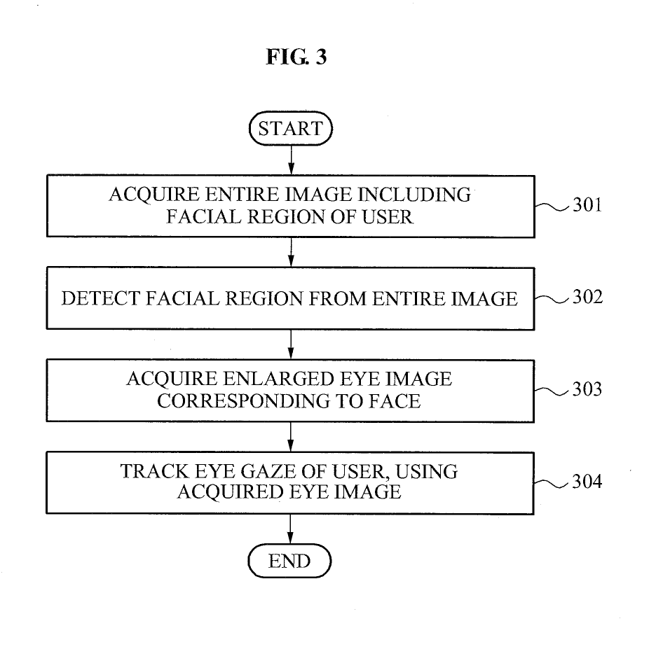

FIG. 3 is a flowchart illustrating a remote gaze tracking method according to an embodiment of the present invention.

The remote gaze tracking method may acquire an entire image including a facial region of a user, using a visible ray (in operation 301).

The remote gaze tracking method may detect the facial region from the acquired entire image (in operation 302).

In the remote gaze tracking method, a wide-angle camera may be used to detect the facial region, and a face width, a distance between eyes, and a distance between an eye and a screen may be acquired using the detected facial region.

For example, the remote gaze tracking method may apply an Adaboost algorithm and a CamShift algorithm in the acquired entire image, and may detect the facial region.

The remote gaze tracking method may acquire an enlarged eye image based on the detected facial region (in operation303).

In the remote gaze tracking method, a narrow-angle camera may be used to acquire the enlarged eye image.

In other words, it is possible to acquire a more precise eye image by panning, tilting, and focusing the narrow-angle camera based on at least one of the acquired face width, the acquired distance between the eyes, and the acquired distance between the eye and the screen.

Accordingly, the remote gaze tracking method may control a movement of the narrow-angle camera, using at least one of the acquired face width, the acquired distance between the eyes, and the acquired distance between the eye and the screen, and may acquire the enlarged eye image corresponding to a face from the narrow-angle camera.

Subsequently, the remote gaze tracking method may track an eye gaze of the user using the acquired eye image (in operation304).

Specifically, the remote gaze tracking method may detect a pupil center position from a detected pupil region, may detect a specular reflection reflected from the pupil region, and may track the eye gaze of the user, using the detected pupil center position and the specular reflection.

The remote gaze tracking method may verify the detected pupil region, and may measure a fatigue level of the user. When the measured fatigue level is equal to or greater than a threshold, at least one of a hue, a brightness, and a saturation of an image displayed on a screen may be controlled to be adjusted.

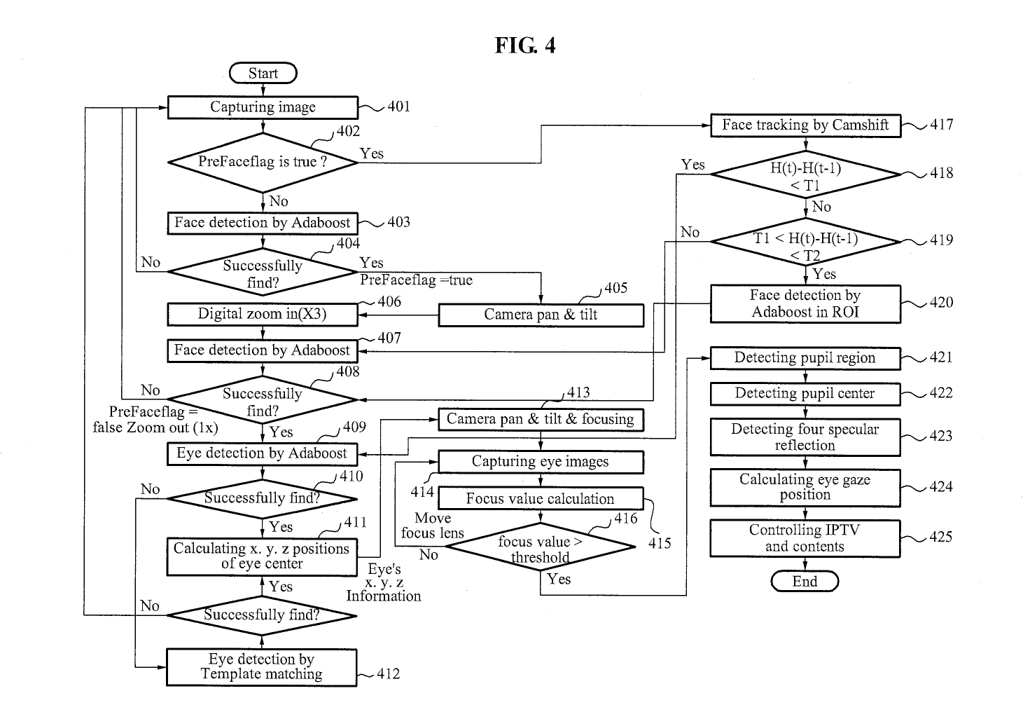

FIG. 4 is a flowchart illustrating in more detail a remote gaze tracking method according to an embodiment of the present invention.

Referring to FIG. 4, when a wide-angle camera receives an input of a captured image (in operation 401), the remote gaze tracking method may determine whether a PreFaceflag is true (in operation 402). Here, the PreFaceflag may indicate whether a face has been detected from a previous frame.

When the PreFaceflag is false, that is, when the face has not been detected from the previous frame, the remote gaze tracking method may detect a face of a user by using an Adaboost algorithm in the captured image (in operation 403).

The remote gaze tracking method may determine a detection result of operation 403 (in operation 404). When the face is not detected, the remote gaze tracking method may revert to operation 401.

As a determination result of operation 404, when the face is detected, the remote gaze tracking method may change the PreFaceflag to a true value, may pan and tilt a narrow-angle camera to a position of the face of the user (in operation 405), and may enlarge an image using a digital zoom (3×) (in operation 406).

The wide-angle camera may acquire a face image with a resolution of 640*480 pixels, and may increase the resolution of the face image using a zoom lens to solve a problem that a detection accuracy is reduced due to a reduction in size of a target region to be detected during detection of a face position and eye position of a user. However, since a view angle of the wide-angle camera is narrowed at first, it may be difficult to detect position of users sitting on various points in front of a TV.

Accordingly, after a system is initially started, the remote gaze tracking method may adjust the face of the user to a region near the center of an image of the wide-angle camera, by detecting the face of the user, and performing panning and tilting (in operation 405), and may perform digital zoom so that the face position and eye position may be easily detected (in operation 406).

Here, the panning and tilting may be performed so that the face of the user may be included in an enlarged digital zoom.

In operation 406, when the image of the wide-angle camera is enlarged by the digital zoom, the remote gaze tracking method may detect the face of the user by using the Adaboost algorithm again (in operation 407). Here, whether the face is detected may be determined (in operation 408). When the face is not detected, the remote gaze tracking method may refer to operation 401.

The remote gaze tracking method may again use an Adaboost eye detection algorithm to detect an eye from a facial region detected in operation 408 (in operation 409).

Whether the eye is normally detected using the eye detection algorithm may be determined (in operation 410). When the eye is detected, a pupil position (x, y) in the captured image may be calculated, and a distance z from the wide-angle camera to the user may be calculated using face width information that is detected already by the Adaboost algorithm in operation 407 (in operation 411).

To predict the distance z, a general camera model such as a pinhole camera model and the like may be used.

Additionally, the distance z may be predicted based on an average of face widths of general users.

When the eye is not detected as a determination result of operation 410, the remote gaze tracking method may detect the eye through template matching, x, y, and z positions of the eye may be calculated as described above (in operation 412).

Information on the x, y, and z positions calculated in operation 411 may be transferred to a gaze tracking processor.

As a determination result of operation 408, when face detection fails, the remote gaze tracking method may revert to operation 401. When the above-described PreFaceflag has the true value in operation 402, a CamShift algorithm may be used to track the facial region (in operation 417).

More specifically, the CamShift algorithm may be used to measure a similarity of a histogram of an image. The CamShift algorithm may store, as an initial area, a histogram of the detected facial region, and may compare the stored histogram with a next frame of the image obtained from the wide-angle camera.

Here, when a facial region of a current frame is stored, when histogram information is updated, and when a new frame is input, the similarity of the histogram may be measured again in the current frame, using the previously stored histogram.

The remote gaze tracking method may determine whether a histogram difference between a facial region of a previous frame and the facial region of the current frame is equal to or less than a threshold T1 (T1=0.02) (in operation 418). In other words, when the similarity is equal to or greater than 98%, the remote gaze tracking method may revert to operation 409.

As a determination result of operation 418, when the histogram difference is equal to or greater than the threshold T1 (T1=0.02), whether the histogram difference is equal to or greater than the threshold T1 and is equal to or less than a threshold T2 (T2=0.05) may be further determined (in operation 419).

When the histogram difference is equal to or greater than the threshold T1 and is equal to or less than the threshold T2 (T2=0.05), that is, when the similarity ranges from 95% to 98%, the Adaboost algorithm may be performed in the current frame based on a Region Of Interest (ROI) of the facial region of the previous frame (in operation 420).

As a determination result of operation 419, when the similarity of the histogram is less than 95%, the remote gaze tracking method may revert to operation 407.

Face tracking by the CamShift algorithm may have an advantage of being significantly faster processed than face tracking by the Adaboost algorithm.

When the face is not detected by the Adaboost algorithm, or when a wrong facial region is found, the face detection may be performed by again using the Adaboost algorithm due to low similarity between frames, even when the face tracking is started.

For example, when the remote gaze tracking method reverts to operation 407 since the similarity of the histogram is less than 95% as the determination result of operation 419, that is, when the face detection by the CamShift fails, face detection by the Adaboost may be performed again in operation 407. Here, when the face detection succeeds in operation 408, operation 409 may be performed. Conversely, when the face detection fails, it may be regarded that the face of the user is not included in the image captured from the wide-angle camera, and accordingly, the PreFaceFlag may be set to false, and the digital zoom of the wide-angle camera may be reduced to lx. Subsequently, operation 401 may be performed.

Since operation 409 corresponds to a case in which the face detection is successfully performed in operation 408, eye detection from the detected facial region may be performed. In operation 410, whether the eye detection is performed may be determined. When the eye detection succeeds, the remote gaze tracking method may revert to operation 411. Conversely, when the eye detection fails, the remote gaze tracking method may revert to operation 412.

Since operation 412 corresponds to a case in which the eye detection fails in operation 411, eye detection by template matching may be performed. Whether the eye detection by the template matching succeeds may be determined in operation #2. For example, when the eye detection by the template matching succeeds in operation #2, the remote gaze tracking method may revert to operation 411. Conversely, when the eye detection by the template matching fails, the remote gaze tracking method may revert to operation 401.

The information on the x, y, and z positions calculated from the image of the wide-angle camera in operation 411 may be transferred to the gaze tracking processor, and panning, tilting, and focusing of a camera may be performed (413).

Subsequently, an image may be captured from the narrow-angle camera (414), and a focus value may be calculated (415). Here, the captured image may be determined to have a resolution of 1600*1200 pixels.

In the present invention, to track an eye gaze, a high quality image that shows an eye and that is correctly in focus at a level greater than a predetermined level may be required. As described above, in the wide-angle camera, the face position and eye position of the user may be detected, and the distance Z may be predicted. Here, since the calculated distance z is inaccurate, a focus value needs to be calculated to determine whether the focusing is correct.

When the calculated focus value is less than a threshold that is used to determine whether focusing is correct, operations 414, 415, and 416 of moving a focal lens of a camera based on the focus value may be repeatedly performed.

As a determination result of operation 416, when the focus value is greater than a threshold, a pupil region may be detected from the image captured from the narrow-angle camera in operation 414, by determining that the focusing is correct (in operation 421).

Here, a circular edge detection algorithm, a binarization process, a labeling process, and the like may be used to detect the pupil region.

A pupil center position may be detected from the detected pupil region (in operation 422), and four pupil specular reflections obtained by reflecting four infrared lightings from a pupil may be detected (in operation 423).

Finally, an eye gaze position may be calculated (in operation 424). Selection functions, such as eye-blinking, a time kept for gaze position, and the like, may be combined using the eye gaze position calculated by the gaze tracking processor, and an IPTV and contents may be controlled (in operation 425).

The remove gaze tracking method according to an embodiment of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

According to an embodiment of the present invention, a user may control an IPTV in a long distance, without wearing a separate apparatus.

According to an embodiment of the present invention, a user may control the IPTV by merely staring at a TV screen, instead of using a remote control of a complex button input mode, and may conveniently use, a variety of content.

According to an embodiment of the present invention, it is possible to provide a customized advertisement by recognizing an eye gaze position of a user located in a long distance.

According to an embodiment of the present invention, it is possible to determine whether a viewer is absent in front of a TV or is sleeping, and to provide a power-saving function by turning off the TV.

According to an embodiment of the present invention, it is possible to analyze a fatigue level of a user viewing a TV, and to control an image in order to reduce the fatigue level.

According to an embodiment of the present invention, it is possible to provide a screen optimized to various postures of a viewer, by rotating content displayed on the screen based on both eye positions detected from a user viewing a TV.

According to an embodiment of the present invention, it is possible to provide a home security surveillance function or a child monitoring function.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A remote gaze tracking apparatus, comprising:
an infrared lighting unit to radiate a specular reflection of an infrared ray;
a gaze image acquiring unit to acquire an entire image using a visible ray, and to acquire an enlarged eye image corresponding to a face of a user, the entire image including a facial region of the user; and
a gaze tracking processor to track an eye gaze of the user, using the acquired entire image and the enlarged eye image.

2. The remote gaze tracking apparatus of claim 1, wherein the gaze image acquiring unit comprises a wide-angle camera to acquire the entire image, and
wherein the gaze tracking processor detects the facial region from the acquired entire image, computes a face width, a distance between eyes, and a distance between an eye and a screen, from the detected facial region, and tracks the eye gaze of the user.

3. The remote gaze tracking apparatus of claim 2, wherein the gaze tracking processor applies an Adaboost algorithm and a CamShift algorithm in the acquired entire image, and detects the facial region.

4. The remote gaze tracking apparatus of claim 2, wherein the gaze tracking processor applies an Adaboost algorithm and an adaptive template algorithm in the detected facial region, and computes at least one of the distance between the eyes, and the distance between the eye and the screen.

5. The remote gaze tracking apparatus of claim 1, wherein the gaze image acquiring unit comprises a narrow-angle camera to acquire the enlarged eye image, and
wherein the gaze tracking processor controls a movement of the narrow-angle camera, based on the acquired entire image, so that the enlarged eye image is acquired.

6. The remote gaze tracking apparatus of claim 1, wherein the gaze tracking processor detects a pupil region of the user based on the acquired enlarged eye image.

7. The remote gaze tracking apparatus of claim 6, wherein the gaze tracking processor detects a pupil center position from the detected pupil region, detects the specular reflection reflected from the pupil region, and tracks the eye gaze of the user.

8. The remote gaze tracking apparatus of claim 6, wherein the gaze tracking processor detects the pupil region using at least one of a circular edge detection algorithm, a binarization process, and a labeling process.

9. The remote gaze tracking apparatus of claim 6, wherein the gaze tracking processor verifies the detected pupil region, and measures a fatigue level of the user.

10. The remote gaze tracking apparatus of claim 9, wherein, when the measured fatigue level is equal to or greater than a threshold, the gaze tracking processor controls at least one of a hue, a brightness, and a saturation of an image displayed on a screen.

11. The remote gaze tracking apparatus of claim 1, wherein the gaze tracking processor controls an image displayed on a screen to be rotated, using the enlarged eye image.

12. A remote gaze tracking method, comprising:
acquiring an entire image using a visible ray, the entire image including a facial region of a user;
detecting the facial region from the acquired entire image;
acquiring, from the detected facial region, a face width, a distance between eyes, and a distance between an eye and a screen;
acquiring an enlarged eye image corresponding to a face of the user, using at least one of the acquired face width, the acquired distance between the eyes, and the acquired distance between the eye and the screen; and
tracking an eye gaze of the user, using the acquired entire image.

13. The remote gaze tracking method of claim 12, wherein the detecting of the facial region comprises applying an Adaboost algorithm and a CamShift algorithm in the acquired entire image, and detecting the facial region.

14. The remote gaze tracking method of claim 12, wherein the acquiring of the enlarged eye image comprises:
controlling a movement of a narrow-angle camera, using at least one of the acquired face width, the acquired distance between the eyes, and the acquired distance between the eye and the screen; and
acquiring the enlarged eye image corresponding to the face, from the narrow-angle camera.

15. The remote gaze tracking method of claim 12, wherein the tracking of the eye gaze of the user comprises:
detecting a pupil center position from a detected pupil region;
detecting a specular reflection reflected from the pupil region; and
tracking the eye gaze of the user, using the detected pupil center position and the detected specular reflection.

16. The remote gaze tracking method of claim 12, further comprising:
verifying the detected pupil region, and measuring a fatigue level of the user; and
controlling at least one of a hue, a brightness, and a saturation of an image displayed on a screen, when the measured fatigue level is equal to or greater than a threshold.
